(19) United States
(12) Patent Application Publication
(10) Pub. No.: US 2006/0249001 A1
(43) Pub. Date: Nov. 9, 2006

(54) Device for processing the side edges of sheet materials or a sheet shaped component

(75) Inventors: Alexander Egidi, Parkstetten (DE); Daniel Enge, Ulm (DE); Karl-Heinz Fuller, Neu-Ulm (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/393,203

(22) Filed: Mar. 30, 2006

(30) Foreign Application Priority Data
Mar. 31, 2005 (DE) 10 2005 014 630.9

(51) Int. Cl. B23D 19/00; B26D 1/14

(52) U.S. Cl. 83/508.2; 83/499

(57) ABSTRACT

A device (10) for processing side edges (2) of sheet shaped materials (1) or a sheet shaped component with the aid of at least one cutting tool unit, including at least one cutting tool such as for example a rotating cutting tool (3), which is adjustably received in a mount (4), wherein the cutting tool unit is adjustable with the aid of a first adjusting device (5), wherein the cutting tool unit is adjustable about the angle orientation α with the aid of a second adjusting device, in particular the angle orientation α of the rotation axis (9) of the cutting tool (3) relative to a surface (8) of the material (1) or the component.

### CROSS REFERENCE TO RELATED APPLICATION

This application claims the benefit of German Application No. DE 10 2005 014 630.9-14 filed Mar. 31, 2005.

### BACKGROUND OF THE INVENTION

1. Field of the Invention

The invention concerns a device for processing side edges of sheet-shaped materials or a sheet shaped component with the aid of at least one cutting tool, such as a rotating cutting tool, which is received in a chock or holder and is positionable with the aid of an adjusting device.

2. Description of Related Art

From DE 100 11 755 A1 a process and a device for production of rolled sections or rolled components is already known of which the cross section changes along the longitudinal axis, wherein the deforming rollers are moved translationally with a part perpendicular to the longitudinal orientation of the sheet and, besides rotating about the rotation axis of the rollers, can be pivoted or swiveled about at least one additional rotation axis. The deforming rollers can be adjusted with the aid of an adjustment device. A disadvantage herein is however that a device of this type is not suited for cutting processing of the side edges of sheet metal materials or components.

From DE 34 43 849 A1 an edge trimming apparatus for a steel sheet is known, which in a plant or a conveyor line makes possible the continuous side cutting of the steel band. It is a disadvantage herein however that the device can essentially produce cutting contours on the planar steel sheet, while a cutting of the component, in particular in the raised component areas, is not possible.

From DE 34 21 331 C2 there is beyond this known a rotary disc cutter for the longitudinal trimming of a steel strips and bands, which discloses the angular adjustment of an upper blade shaft relative to a fixed lower blade shaft, in order to be able to adapt the cutting gap to the thickness of the sheet. A disadvantage herein is however that the cutting disc scissors can produce an essentially straight cut contour parallel to the direction of travel of a sheet or band and therewith is not suited for a varied cutting contour or even the cutting of a component, in particular in the raised component areas.

Another very complex method for production of contour cutting in sheets occurs with the aid of disc cutters or punch tools as known for example from DE 198 24 710 A1. A disadvantage herein is however that by punching tools high production costs occur and the cutting tools cannot be adapted or can only very limitedly be adapted to a changed cutting geometry. Beginning with the above described state of the art, the present invention is concerned with the task of providing a device for processing of sheet-like materials or a sheet like component, so that over the entire length of the material or the component individually designed cutting contours can be produced and a, for example, profiled component can be cut in the raised shank or flanged area.

### SUMMARY OF THE INVENTION

The task is solved in accordance with the invention thereby, that the device for processing of cutting edges of sheet shaped materials or a sheet shaped component includes at least one cutting tool unit, wherein the cutting tool unit includes at least one cutting tool, and in particular a rotating cutting tool, which is adjustably received in a receptacle, and is adjustable with the aid of a first adjusting device, and wherein the cutting tool unit is adjustable about an angular orientation α with the aid of a second adjusting device, in particular the angular attitude α of the rotation axis of the cutting tool with reference to the surface of the material or the component.

The advantage of this design is that the cutting tool unit is so adjustable with the aid of the first adjusting device that contours of various design can be formed on the cut edge of the material or the component. With the aid of the first adjusting device, which can be controlled by a computer, an individually designed cutting edge or as the case may be contour of the edge can be produced in a flat or planar sheet shaped material in simple manner with very high rate of advance, which can be greater than 50 m/min. The desired cutting contour can be stored in a computer program, which serves for the precise control of the first adjusting device and therewith the cutting tool of the cutting tool unit. With such an easily adjustable device a very high rate of advance can be achieved with conventional cutting tools, which can be provided either rotatable or pivotable, in comparison to laser cutting. With the aid of this controlled or guided device the cutting process can be completely automated.

A further advantage is that the cutting tool is adjustable about the angle α via the second adjusting device. Thereby the inventive device is in particularly advantageously useable for cutting of already deformed and/or raised cross-sectional areas of a rolled profile, in particular a flexible rolled profile component, since the device produces variously designed cutting contours in the flanged and/or shank area of a component of this type. This is made possible by the adjustability of, for example, the angular orientation α of the rotation axis of the cutting tool by the second adjusting device.

Analogous to the first adjusting device, the second adjusting device is likewise controllable with the aid of a control unit and the cutting process can be completely automated in the same mode and manner. The first and second adjusting device could therein be coupled or independent of each other, or multiple adjusting devices could be controlled, wherein in particular a computer assisted control unit for both adjusting devices would seem logical. In an advantageous embodiment the chock or holder for receiving the cutting tool is adjustable in the plane of the direction of advance of the material or the component and/or transverse to this direction of advance.

The advantage therein is that a very precise cutting contour is possible, since the cutting tool receives a very precise command via the control unit, in order to produce the cutting contour recorded in the computer. With the inventive device both translational as well as rotational movements can be carried out, so that the device or as the case may be the cutting tool unit can carry out various process movements, in order to produce various cutting contours. The cutting speed can be between 15 and 100 m/min, preferably 20 to 50 m/min. The speeds are determined by the material to be cut. A further possibility, according to a further development of the invention, is that the height position of the cutting tool unit and/or one rotation axis of a cutting tool is variable with regard to the surface of the material or component to be cut.

This makes it possible in an advantageous manner to cut materials which are not planar and therewith extends the spectrum of employment of the device. Above all this makes possible however the variable cutting of components, in particular longitudinally extending, flexible roller profiled components, in the shank or vertical area of the profiled cross section.

It is further advantageous, that the angle position between the rotation axis of the cooperating cutting tool with regard to the surface of the material or component are variable together, or that the angle orientation between the respective rotation axis and the surface are individually variable. Thereby also, each desired profile or each cutting edge can be produced on the material or component.

It is advantageous for this, that the angled position of the rotation axis of the upper rotating cutting tool, relative to the angled position of the rotation axis of the lower rotating cutting tool, during adjustment of the cutting tool is the same size or varying size.

According to a preferred embodiment of the inventive solution, it is finally provided that the control movement of the chock or holder is decoupled from the control movement of the cutting tool. Thereby the possibilities of employment of the cutting tool are expanded and any profiling of the cutting edge of the material or component is possible.

Of particular significance for the present invention is that the holder or carrier of the cutting tool is adjustable with the aid of a first motor and/or of control cylinders on a sled in or transverse to the direction of advance of the sheet metal or the sheet strip.

In association with the inventive design and arrangement it is of advantage, that the holder or carrier, with regard to the surface of the sheet or the sheet band, exhibits an upright axis, about which the holder or carrier is rotatable or orbitable with the aid of a second motor.

It is further of advantage that the height position of the mount is variable with the aid of a second motor or a third motor.

Besides this, it is advantageous that one or more motors are adjustable depending upon a control device.

It is further of advantage that the cutting tool is pivotable with the aid of the motor or a rack-and-pinion drive about a vertical axis. The mount can, in the same simple manner, be moved transverse to the direction of advance of the sheet or the sheet band by an actuator or servo motor. Analogous to the above description, the adjustability of the cutting tool unit is pivotable about the angular position α driven by motor in similar mode and manner, in particular via an electric servo motor.

In a further preferred embodiment of the inventive device the cutting tool unit exhibits, on an upper shaft axis, an upper roller for cutting, and a further, fixedly mounted roller, wherein the additional roller is overlapped by a fixedly mounted bottom or lower roller for cutting on a lower shaft axis and in cooperation therewith forms a gap through which the material or the component is guided and wherein the upper roller is mounted displaceable on the upper shaft axle or axis.

The advantage of this design is that therewith the fixedly mounted rollers remain in engagement on the blade shaft during the entire process and so supplementally positions and/or guides the material or the component, while the displaceably mounted upper roller serves only for cutting and only then comes into employment, that is, is only advanced toward the material or component, when a cutting process is necessary.

### BRIEF DESCRIPTION OF THE DRAWINGS

Further advantages and particularities of the invention are seen in the patent claims and in the description and in the figures.

There is shown:

FIG. 1 a schematic representation of a cutting unit with upper and lower roller and a first cutting device for the cutting tool;

FIG. 2a-2d four different profile edges of a sheet shaped material;

FIG. 3 a schematic representation of the position of the cutting tool unit; and

FIG. 4 a perspective partial view of the device.

### DETAILED DESCRIPTION OF THE INVENTION

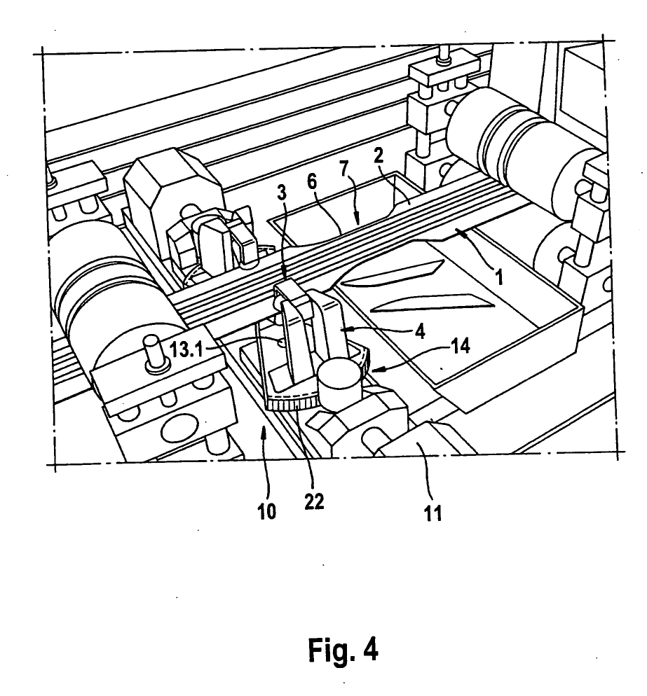

In FIG. 4 a device 10 for flexible sheet contour cutting of sheet bands, sheet plates 1 or components is shown, with which a very individually designed contour cut can be produced on a side or, as the case may be, cut edge 7 of the sheet band 1 or component.

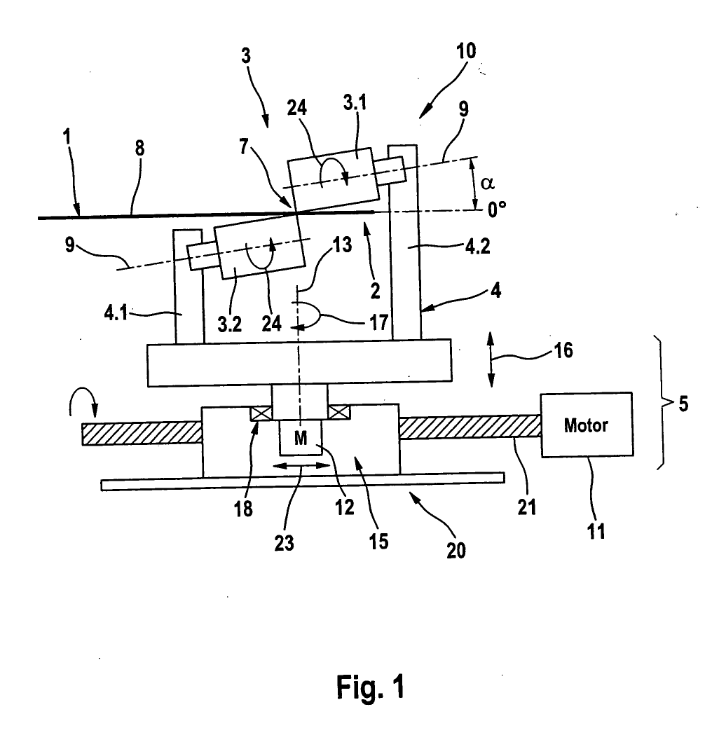

The device 10 for processing of side edges 2 of sheet bands 1 or components is comprised essentially of a mount 4 or, as the case may be, a cutting framework with two upright stands 4.1, 4.2, which serve for receiving of holders, not shown in the figures, for cutting tools 3 or as the case may be an upper roller 3.1 and a lower roller 3.2. With the aid of a rotation axle 9 received in the mount, the cutting tools 3 are mounted in the stands rotatably according to arrow 24. According to the embodiment in FIG. 1 angle α with regard to a surface 8 of the sheet band 1 or component can be greater than 0°, and in cutting the component can preferably be between 0° and 90°. With the aid of the sequentially rolling roller shoulders, a sheet 1 rolling into a unit or, as the case may be, the cutting tool 3, is cut.

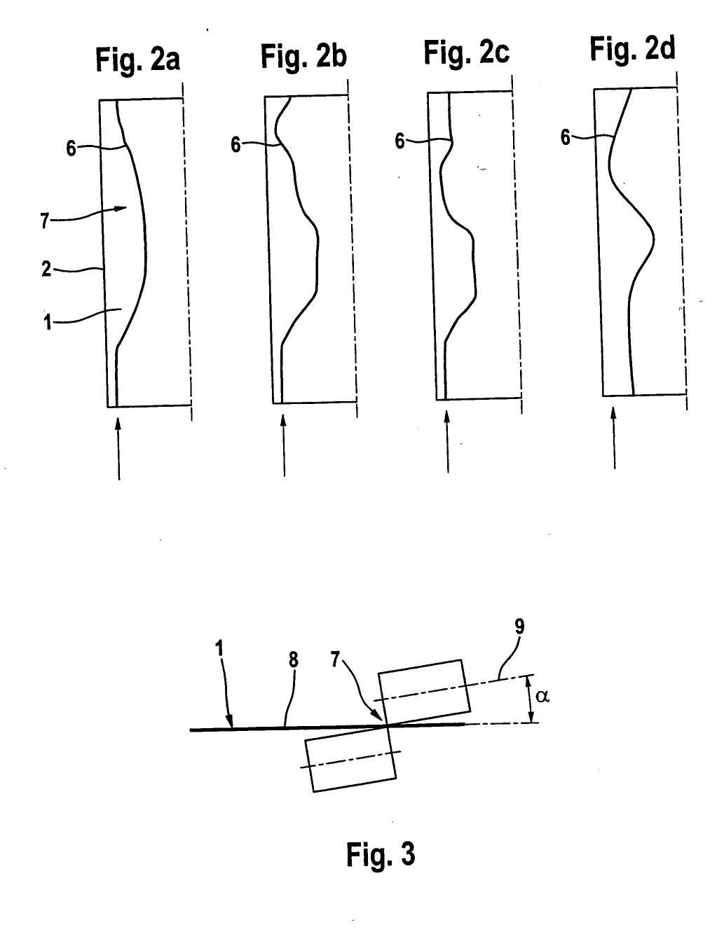

The cutting tool 3 (FIG. 1) is adjustable with the aid of an adjusting device 5 in such a manner, that (FIG. 2a through 2d) various design contours 6 can be formed on the cut edge 7 of the sheet 1. For this the mount 4 with the two stands 4.1, 4.2 is received on a carrier device 15 adjustable in height according to arrow 16 and on the other hand is received rotatably according to arrow 17 with the aid of a bearing 18. The height adjustability of the mount 4 can be accomplished with the aid of servo motors or control cylinders not shown in the figures. The mount 4 can be rotated in both directions with the aid of a motor 12.

The mount 4 is mounted to be adjustable in both directions or as the case may be displaceable on a sled 20 according to arrow 23. The adjustment of the entire mount 4 occurs via a spindle drive 21 and via a motor 11, which can be an electric motor or servo motor. The adjustment of the mount 4 or as the case may be the entire framework with the cutting tools 3 can also be undertaken in not shown control means by hydraulic pneumatic or electromechanical means with the aid of a control device as well as a software program in which the desired cutting profile is recorded. Besides a translational or rotational movement of the mount or, as the case may be, the entire framework, the device 10 moves with the aid of the motors 11, 12, according on the controller, following the contour of the sheet cut. Thereby the angular orientation α of the cutting tool 3 or as the case may be cutting tool unit can be varied. The cutting tool 3 can, prior to begin of operation, also be adapted to the sheet or component geometry. For this, it is also possible that the control of the mount 4 and the cutting tool 3 by the control device not shown in the figure are decoupled from each other. It is further possible to have a combined adjustment of the mount 4 and the cutting tool 3 or a decoupled control of mount 4 and cutting tool 3. The two rotation axis 9 of the cutting tool 3 can be collectively or individually varied in their attitude or bearing or location.

According to FIG. 4 the cutting tools 3 are mounted pivotably in the holder 4, which with regard to the surface 8 of the sheet or the sheet band 1 exhibits a vertical axis 13, about which the mount 4 with the cutting tool 3 is rotatable. The mount 4 can be adjustable via the motor 11 as shown in FIG. 4 as in FIG. 1, so that the contours of the sheet or sheet band 1 can be variously designed. The adjustment of the mount 4 can also occur with the aid of a linear motor.

The cutting speed can be between 15 and 100 m/min. It is determined by the material to be cut. The actual cut is, similar as in the case of the subsequent edge cut, carried out by the cutting roller 3 according to FIG. 1.

According to an illustrative embodiment shown in FIG. 4 the cutting tool 3 received in the mount 4 can be rotated or pivoted about a vertical axis 13.1. Further, it is possible that the adjustment of the cutting tool 3 occurs with the aid of a rack-and-pinion 14. The rack-and-pinion drive 14 is comprised of a half of a gear wheel 22 provided on the cutting tool 3, which cooperates with a gear ring or an annular gear provided on the axle 13.1 not shown in the drawing. The mount 4 can be moved transverse to the direction of advance of the sheet or the sheet band 1 in the same simple manner via a servo motor not shown in the drawing.

1-13. (canceled)

14. A device (10) for processing side edges (2) of sheet material (1) or a sheet shaped component with the aid of at least one cutting tool unit, including at least one cutting tool which may be for example a rotating cutting tool (3), which is received adjustably in a mount (4), wherein the cutting tool unit is adjustable with the aid of a first adjusting (5), thereby characterized, that the cutting tool unit is adjustable about the angle position α with the aid of a second adjusting device, in particular the angle orientation α of the rotation axis (9) of the cutting tool (3) with regard to the surface (8) of the material (1) or the component.

15. A device according to claim 14, wherein,
the cutting tool unit is adjustable in such a manner with the aid of the first adjusting device (5), that varyingly designed contours (6) are formed on a cutting edge (7) of the material (1) or component, and/or
the cutting tool unit is so adjustable with the aid of a second adjusting device, that various contours can be formed on a flange and/or shank of a roller profiled component, in particular a flexible roller profiled component.

16. A device according to claim 14 wherein the mount (4) for receiving the cutting tool (3) is adjustable in the plane of the direction of advance of the material (1) or a component or transverse to the direction of advance.

17. A device according to claim 14, wherein the height position of the rotation axis (9) of the one cutting tool (3) is variable with regard to a surface (8) of the material (1) or component to be cut.

18. A device according to claim 14, wherein the angular orientation α between the rotation axes (9) and the surface (8) are individually variable.

19. A device according to claim 14, wherein the angle position α of the rotation axis (9) of the upper rotating cutting tool (3) relative to the angle position α of the rotation axis (9) of the lower rotating cutting tool (3) during adjustment of the cutting tool (3) remains the same or is variable.

20. A device according to claim 14, wherein the cutting movement of the cutting tool unit about the orientation angle α is decoupled from the control movement of the mount (4).

21. A device according to claim 14, wherein the mount (4) of the cutting tool unit is adjustable with the aid of a first motor (11) and/or of control cylinders on a sled (20) in or transverse to the direction of advance of the material (1) or component.

22. A device according to claim 14, wherein the mount (4) with regard to the surface (8) of the material (1) or component exhibits a vertical axis (13), about which the mount (4) is rotatable with the aid of a second motor (12).

23. A device according to claim 14, wherein the height position of the mount (4) is adjustable with the aid of the second motor (12) or a third motor.

24. A device according to claim 14, wherein one or more motors (11, 12) are provided responsive to a control device for adjusting the first and/or second adjusting device.

25. A device according to claim 14, wherein the cutting tool unit is pivotable about a vertical axis (13.1) with the aid of a motor (12) or a rack-and-pinion drive (14).

26. A device according to claim 14, wherein the cutting tool unit exhibits besides an upper roller (3.1) on the upper shaft axis α further roller, which is completely overlapped by a lower roller (3.2) and in cooperation with the lower roller (3.2) forms a gap, through which the material (1) or the component must be guided, and that the upper roller (3.1) is displaceably mounted on the upper shaft axis.
